(19) United States
(12) Patent Application Publication
(10) Pub. No.: US 2009/0112699 A1
(43) Pub. Date: Apr. 30, 2009

(54) DONOR AFFINITY TRACKING SYSTEM

(76) Inventor: Clifford Dirk Rinker, Valencia, CA (US)

Correspondence Address: Shlesinger, Arkwright & Garvey, LLP;Attention: Josefine P. de Leon, Suite 600, 1420 King Street, Alexandria, VA, 22314-2750, US

(21) Appl. No.: 12/184,198

(22) Filed: Jul. 31, 2008

(30) Foreign Application Priority Data
Aug. 1, 2007 (CA) 2,601,465

(51) Int. Cl. G06Q 10/00; G06Q 50/00; G06F 9/44

(52) U.S. Cl. 705/10; 706/52

(57) ABSTRACT

A donor affinity tracking system for non-profit enterprises in which information from a client donor database is combined with information obtained via a survey data acquisition system using an algebraic scoring system and information from a data-warehouse to generate customized reports and real-time results delivered via a client portal. The data comprises donor satisfaction responses to questionnaires, weighted according to responses to donor affinity responses to questionnaires, and enables advising the donee on improving the scores of the most crucial donor affinity factors and predicting future donations by donors in order to prioritize fund-raising efforts.

### FIELD OF THE INVENTION

This invention relates generally to the field of data-processing methods involving information obtained via surveys and the combination of that information with information from a data-warehouse.

### BACKGROUND

Recent years have shown an increase in the number of organizations competing for the same donor funds, which have not increased at the same rate as the charitable need. Large-scale disaster relief has used-up a significant proportion of the available charitable donor funds. Macro issues affecting the charitable fundraising industry include uncertainty about the overall economy, inflation, and demographic changes in the population. Micro issues include charitable leadership, charitable organization staffing, brand awareness of the charity and mission, and lastly and most importantly ‘affinity’ which is related to satisfaction with and loyalty to the particular charitable organization.

It is this later ‘affinity’ aspect which the present invention seeks to address. The non-profit industry has traditionally been weak in monitoring donor affinity, basing its understanding on measurements of giving behavior alone represented by records of giving recency, frequency and amount. Donor behavior is a complex web of interrelated attitudes, impulses, checks and balances, which cannot realistically be explained by behavior alone. This reliance on behavioral data results in an unfortunate loss of revenue for the non-profits and a lack of data as to whether donors are achieving their objectives in respect to their charitable giving.

The few non-profit organizations which measure donor attitudes have historically relied upon point-in-time donor affinity surveys developed by professional marketing research firms and administered via traditional methods such as telephone and mail. The results of such surveys are summarized and reported to clients, taking considerable time and expense. The survey report provides useful information, but lacks the detailed information, metrics, and predictive power of the method of the present invention.

Effectively worded questionnaires that specifically address donor concerns can be seen to dramatically improve donor responsiveness to solicitation mailings and other donor contact.

Existing donor data analysis methods can distort, minimize or amplify certain donor behaviors at the expense of others, which causes problems when the data is used for fund raising planning. Customer satisfaction researchers have long known that purchase behavior is an incomplete predictor of future actions, and that satisfaction data helps to fill in gaps in a customer's profile.

Also, existing survey research leaves much to be desired in terms of its applicability. Only the largest non-profits have the financial ability to investigate donor affinity and satisfaction, and the results they achieve are private and proprietary. Therefore, where industry best practices exist, they are not shared and they typically apply only to donors who give to the organization that did the testing. Ultimately, the information is of limited value in improving the processes of soliciting donor funds.

Further, there is little predictive value in such proprietary surveys. This is because the larger non-profits that investigate donor affinity typically test among their own donors—making the donor affinity models they might develop from the data impractical for other non-profits. Independent, multi-sector research has been necessary to establish standards and models of donor affinity that are effective for the wide range of nonprofits that engage in mass fund raising.

### SUMMARY OF THE INVENTION

The present invention solves the problems of limited metrics; limited data; and limited forecasting ability which characterize existing methods of donor analysis and data processing. It solves the metrics, data, and forecasting problems by providing valuable information from a client donor database and combining it with a vast store of data in a data-warehouse including an algorithmic scoring system based on pre-existing parameter and component weights which may evolve over time as an understanding of the underlying factors which contribute to donor affinity and donor affinity evolves. This information can be accessed at will by clients through an electronic client portal which enables clients to generate customized reports in real-time. These reports contain superior donor affinity metrics such as donor satisfaction and donor loyalty which are based on an extensive and continuously updated data-warehouse and new information processing methods. The survey methods—including the parameters and questions used to measure the parameters—may be modified by the addition of new parameters within the spirit of the invention. The reports also incorporate feedback from donors to help the client to improve these donor affinity metrics by providing detailed information that can be used to help donors better achieve their charitable giving objectives.

The present invention is also designed to enhance donor satisfaction by giving donors an opportunity to provide feedback as to how well they feel their charitable giving objectives were realized by the client charitable organization. The focus of the survey is to provide a positive experience to the person completing the survey.

Some of the data consists of responses to standard service satisfaction questions, for example:
1. Informing me how my money is spent
2. Not asking for support too often
3. Offering me some choice in the communications I receive
4. Thanking me appropriately
5. Recognizing the contribution(s) I've made in the past
6. Demonstrating they care about my needs
7. Making it clear why my continued support is needed
8. Giving me opportunities to support [NON-PROFIT] in other (non-financial) ways
9. Using an appropriate style/tone in their communications
   variations of which have been prior used. This data is augmented by implied or stated importance values for the above attributes, in addition to responses to enhanced donor affinity questions, such as:
10. Has your overall experience with [NON-PROFIT] over the past 6 months fallen short of, met or exceeded your expectations?
11. Is [NON-PROFIT] a) one of your favorite organizations, b) among your top three organizations, c) important but you would support others first, or d) not a priority to you?
12. Are you very likely, somewhat likely, undecided, somewhat unlikely or very unlikely to make another financial gift to [NON-PROFIT] in the next 6 months?
13. Do you frequently, occasionally, rarely or never discuss [NON-PROFIT] with friends or family?
   and combined with weighting algorithms to arrive at a future donation score for the donor. The information garnered by questions 1 through 9 is weighted according to how the respondent has answered questions 10 through 13.

The basic set of questions therefore comprises questions seeking the donor's response on the following areas of service quality:
Frequency and responsiveness of donee communications
Content of donee communications
Acknowledgement and/or reciprocation by donee
Nature and approach of the solicitation

The set of enhanced donor affinity thus comprises questions seeking the donor's response in the following areas of questioning:
Donor service quality expectations being met, unmet or exceeded
Whether the donor is likely to give again
Whether the donor is likely to discuss the donee
The priority the donor places on gifts to the donee

The invention thus provides a donor affinity tracking system for non-profit enterprises in which information from a client donor database is combined with information obtained via a survey data acquisition system using an algebraic scoring system and information from a data-warehouse to generate customized reports and real-time results delivered via a client portal.

The data comprises donor satisfaction responses to questionnaires, weighted according to responses to donor affinity responses to questionnaires.

At a basic level, the inventive system is a donor affinity tracking system for non-profit enterprises and fundraising advisors, comprising:
a) a survey data acquisition questionnaire designed to measure a donor's satisfaction with the results of a donation plus the donor's affinity to a donee;
b) a client-donor database
c) a data-warehouse for questionnaire responses
   in which information from the client-donor database is combined with survey data acquired from responses to the questionnaire and with information from the data-warehouse in data analysis that is useful in predicting of future donations from the donor to the donee, and in prioritizing fund-raising and donor affinity improvement efforts.

The questionnaire comprises:
a) a standardized set of questions designed to elicit satisfaction responses useful in measuring key components of a donor's satisfaction with the results of a donation;
b) a customized set of questions designed to elicit affinity responses useful in measuring key components of the donor's affinity for the donee;
c) using the affinity responses to identify which satisfaction components are most important to the donor, in order to weight the donor's satisfaction responses

The result of the data analysis is a future donation score, which can be used to prioritize fundraising efforts and allocation of fundraising expenses according to the future donation scores for various past donors.

The system can also be used to refine donor feedback procedures to result in higher future donation scores.

### BRIEF DESCRIPTION OF THE DRAWINGS

FIG. 1 is a flow-chart overview of the Donor Affinity Tracking System (DATS).

FIG. 2 is a schematic of the Survey Data Acquisition System.

FIG. 3 is an overview of the contents of the Data-Warehouse.

FIG. 4 is a schematic overview of the client portal.

FIG. 5 is a schematic overview of behavioral data transferred from the client-donor database to the data-warehouse.

FIG. 6 is an overview of the algorithm used to score the results within the data-warehouse.

FIG. 7 is an exemplary embodiment of a Landing Page on the Client Portal.

FIG. 8 is an exemplary embodiment of a Results Dashboard.

FIG. 9 is an exemplary embodiment of a Comparison Module.

FIG. 10 is an exemplary embodiment of a Print/Download Module.

FIG. 11 is a box diagram of an Executive Briefing Report

FIG. 12 is a box diagram of a Standard Statistical Banners Report

FIG. 13—Box Diagram of a Customizable Statistical Banners Report

FIG. 14 is a box Diagram of a Web Data Selection Report

FIG. 15 is a box diagram of a Customer Value Analysis Report

FIG. 16 is an illustrative embodiment of a graphical element which can be used in the Customer Value Analysis Report

### DETAILED DESCRIPTION

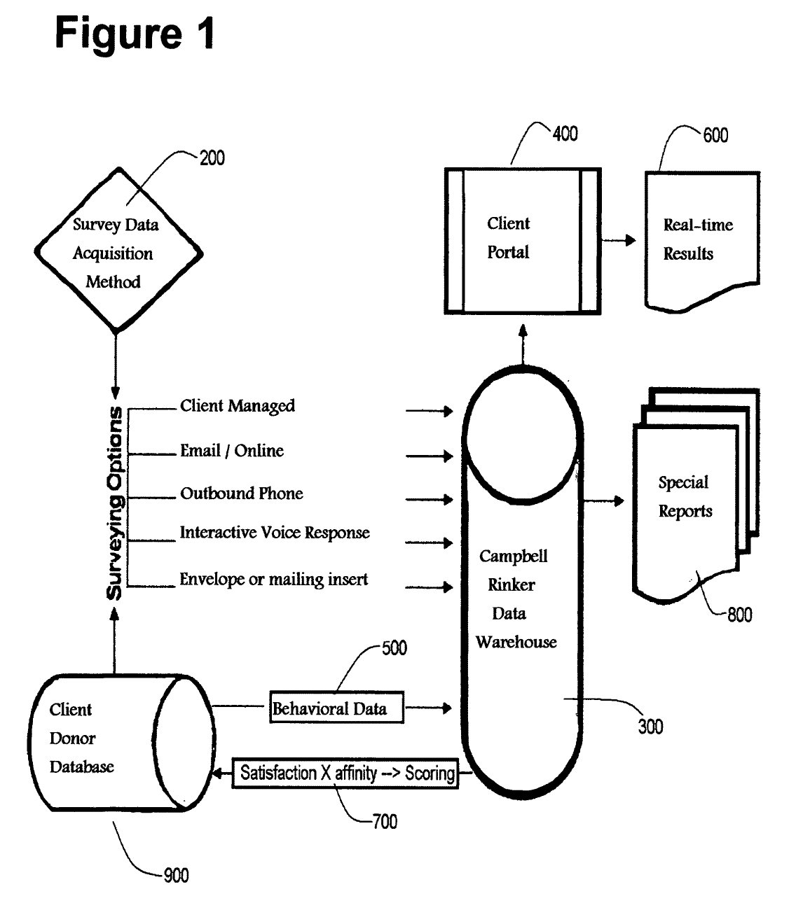

Referring to FIG. 1, the Donor Affinity Tracking System flow-chart is shown in overview form. Behavioral data 500 from a client-donor database 900 is fed into the survey data acquisition method 200 based on information selected by client with respect to various survey options. The survey data acquisition method can be administered via a variety of media. Behavioral data 500 from the client-donor database 900 is also fed into the data-warehouse 300 where it is combined with a wide array of data, benchmarks, and predictive metrics and used to analyze the results from the survey data acquisition method Real-time results 600 are delivered via the client-portal 400 and information from the data-warehouse 300 can also be used to generate a number of special reports 800.

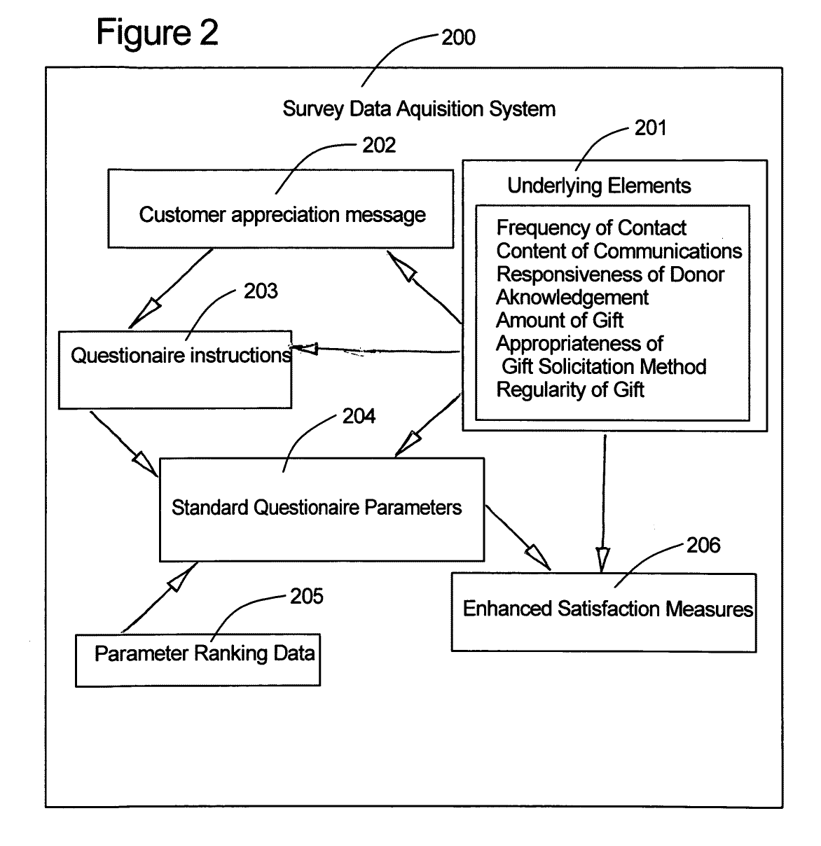

Referring to FIG. 2, a survey data acquisition system 200 is illustrated as comprising a set of underlying elements 201, which feed into other key aspects of the survey data acquisition system 200, such as the customer appreciation message 202, the questionnaire instructions 203, the standard questionnaire parameters 204, and the enhanced affinity measures 206. These other key aspects also influence each other, as the customer appreciation message 202 is conveyed through the questionnaire instructions 203 which seek to measure the standard questionnaire parameters which are then ranked according to the parameter ranking data 205 and then combined with the-enhanced affinity measures 206. The standard questionnaire parameters 204 are derived from a battery of questions which form the initial part of the questionnaire. The enhanced affinity measures include: willingness to renew (also termed renewal likelihood); donor delight; willingness to recommend to others (also termed referral); and the priority that the donor feels toward the charitable organization as compared with other causes. One embodiment of a questionnaire measuring the standard questionnaire parameters 204 (responses to questions 1 through 9 below) and the enhanced affinity measures 206 (responses to questions 10 through 14 below) is as follows:

Please tell us how we rate . . .

Thank you for your recent donation. [Non-Profit] appreciates your support! Please help them improve their relationship with donors by filling out this brief survey and dropping it in the mail. We've already paid for the postage. Or you can take the survey online at . . . www.theratinqscompany.com/example/

Please rate your satisfaction with [NON-PROFIT] over the past six months for each of the following items (leave blank if not applicable). Then check three (3) boxes in the far-right column to show the items you consider most important in your relationship with [Non-Profit].

The Following are some Alternate Versions of Donor Satisfaction Questions that may Substituted in the above Questionnaire:

1. Were you provided with a clear and simple way of understanding how your donation was used?

2. Were you provided with information making it possible for you to support [Non-Profit] in non-financial ways . . .

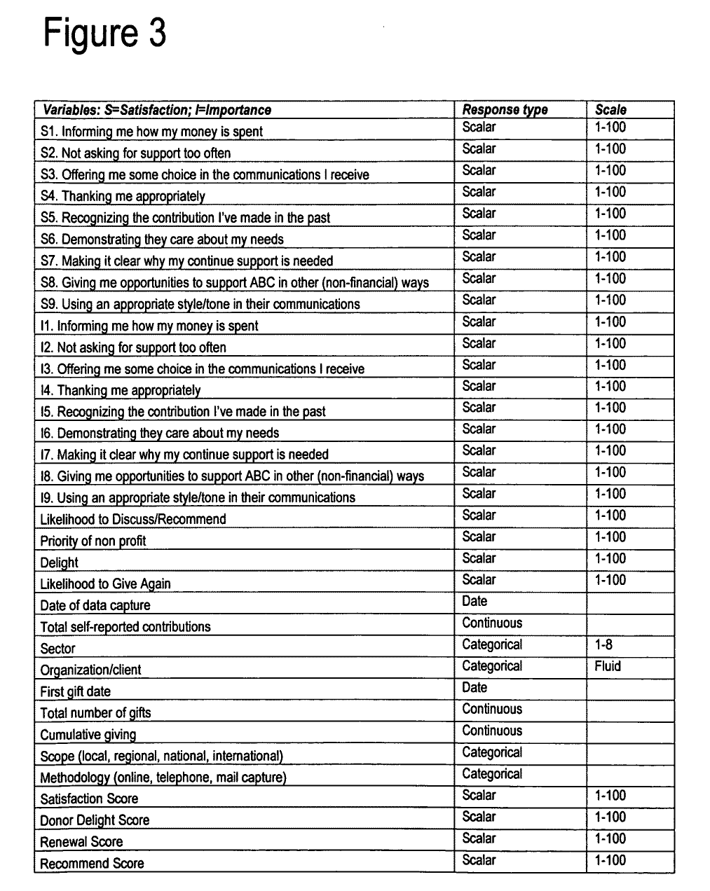

Referring to FIG. 3 a schematic overview of the data-warehouse is provided outlining the purpose, types of data, and specific variables in the data-warehouse. The types of data include survey respondent records, aggregated trend reports, and category specific segmentations. The data is subject oriented, meaning that the data is organized so that all the data elements related to the survey are linked together. The data itself is non-volatile in that it does not change over time. However, the data-warehouse is time-variant in that new data in the database are tracked, summarized and recorded so that reports can be produced showing changes over time. The variables are categorized according to affinity and importance. These characteristics are combined to indicate overall success of the client organization in achieving client affinity.

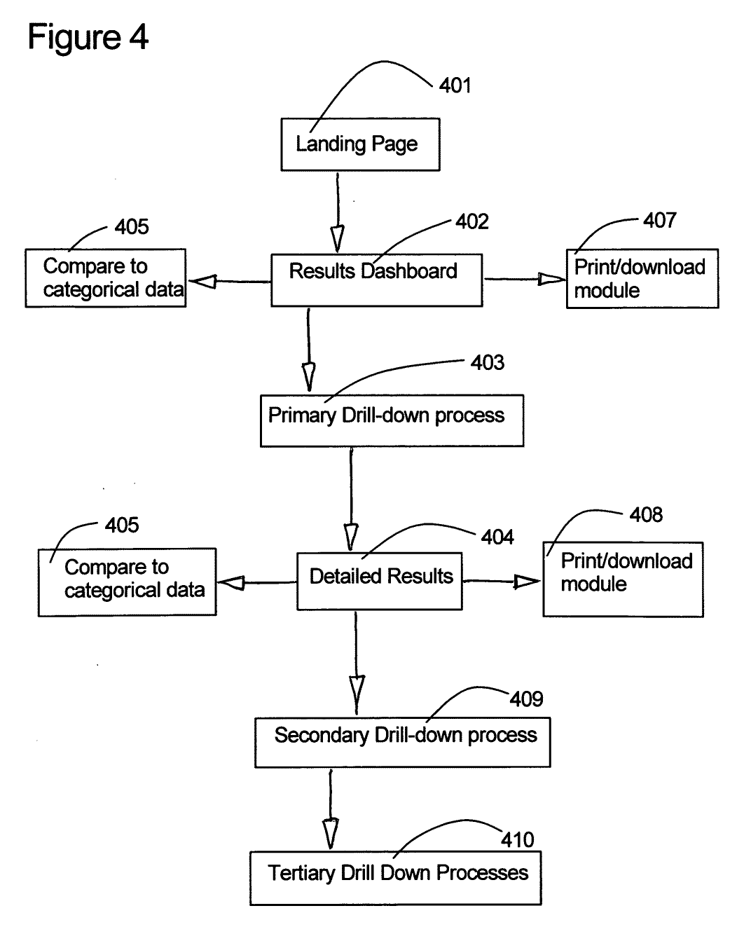

Referring to FIG. 4, schematic overview of the client portal is provided showing the relationship between the landing page 401, the results dashboard 402, the primary drill-down process 403, the detailed results 404, the comparison pages 405 and 406, the print/download functions 407 and 408, the secondary drill down process, and subsidiary drill down processes 410 etc.

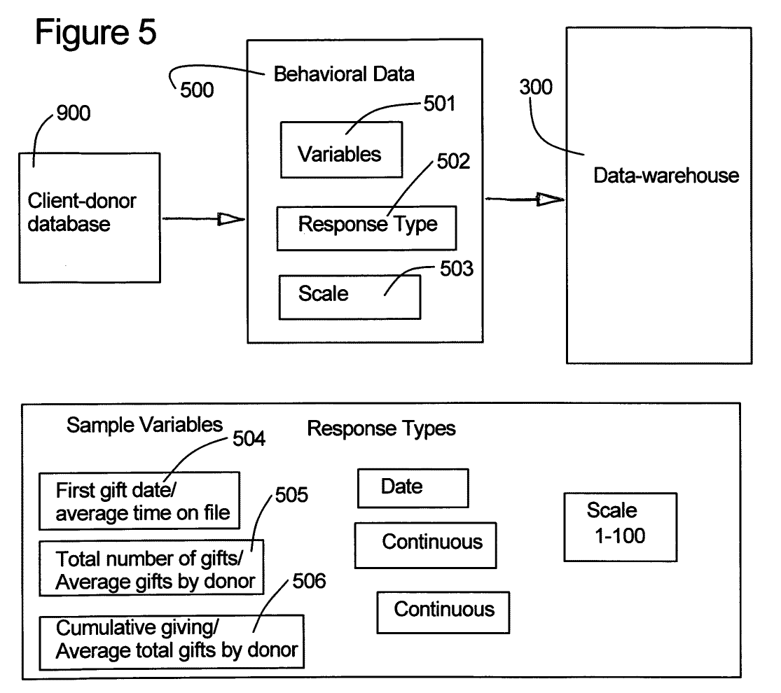

Referring to FIG. 5, a sample of the client data which can be input from the client donor database into the data-warehouse is provided. This information includes selected variables 501, for example: first gift date/average time on file 504, total number of gifts/average gifts by donor 505, cumulative giving/average total gifts by donor 506; response type 502; and scale 503.

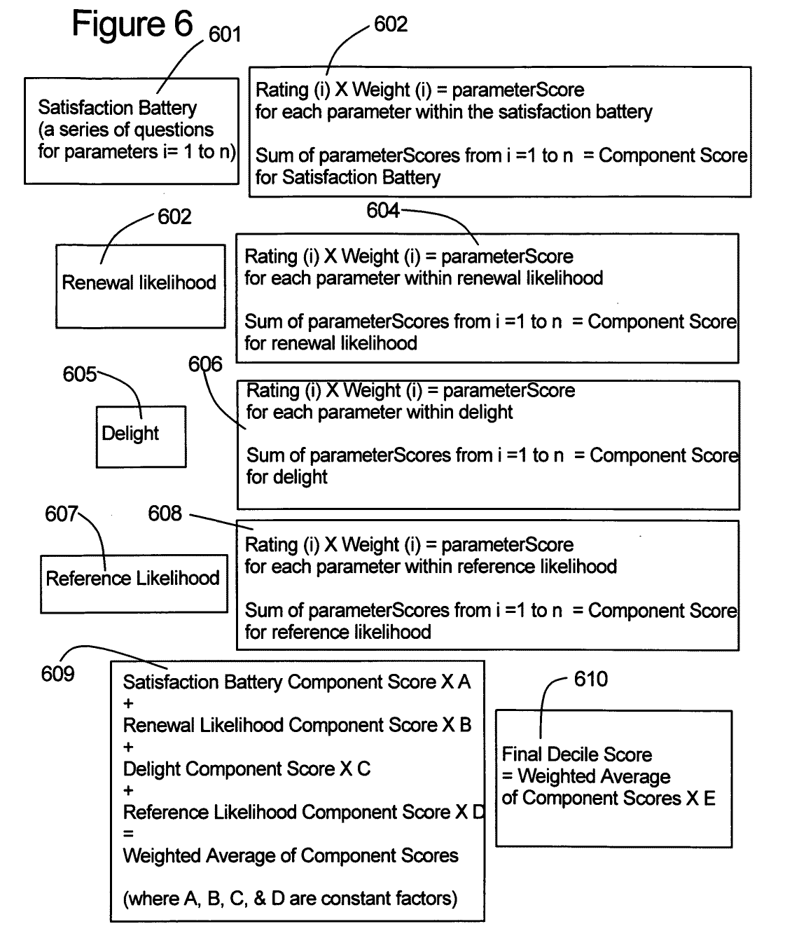

Referring to FIG. 6, an overview of the algorithm used in the data-warehouse to score the data consists of a affinity battery component comprising a series of questions designed to measure parameters from i=1 to n affinity battery 601, with affinity battery component score 602 calculated as a sum of its parameter scores (which are weighted); a renewal likelihood component 603 comprising a series of one or more questions which measure parameters, with renewal likelihood component score 604 calculated as the sum of its weighted parameter scores; a delight component 606 comprising a series of one or more questions designed to measure parameters, with delight component score calculated as the sum of its weighted parameter scores; a reference likelihood component 607 comprised of a series of one or more questions which measure parameters, with the reference likelihood component score 608 calculated as the sum of its weighted parameter scores. The affinity battery component score 602 is multiplied by a constant factor A, and then the result is added to the product of the renewal likelihood component score 604 and constant factor B, the result is then added to the product of the delight component score 606 and constant factor C, which is then added to the product of the reference likelihood component score and constant factor D to produce a weighted average of component scores 609 which is converted to a final decile score by multiplication by constant factor E.

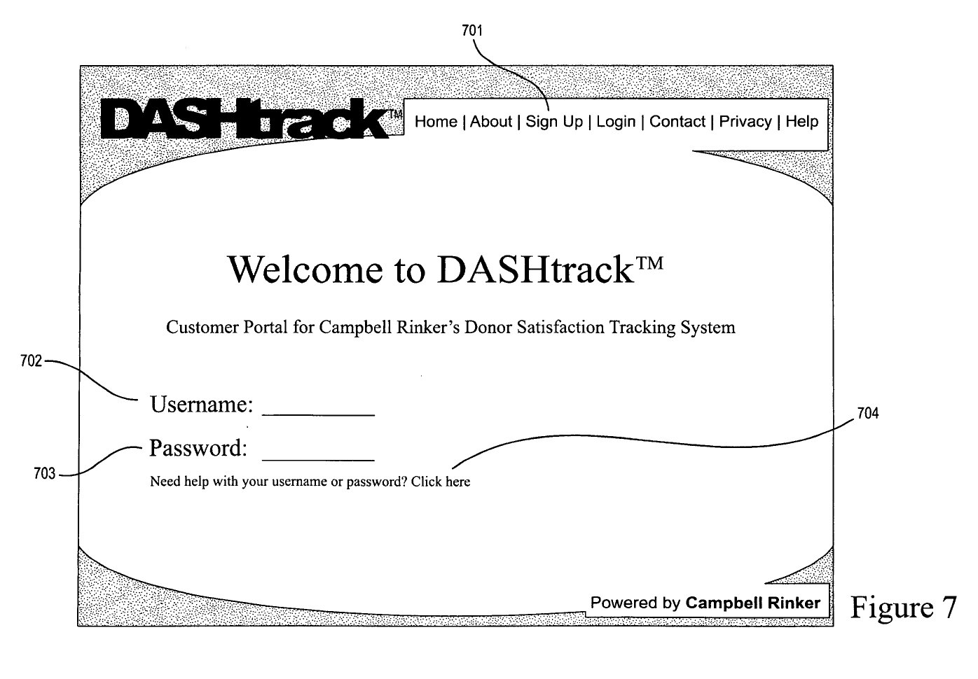

Referring to FIG. 7 an exemplary embodiment of a Landing Page on the Client Portal is shown with navigation bar 701 at the top and username field 702 and password field 703 in the center. The function of the Landing Page is to facilitate access to the Client Portal by prompting the user to enter a username and password. A help link 704 is provided to assist clients who have difficulty with the login process. After the user successfully logs in they are directed to the Results Dashboard.

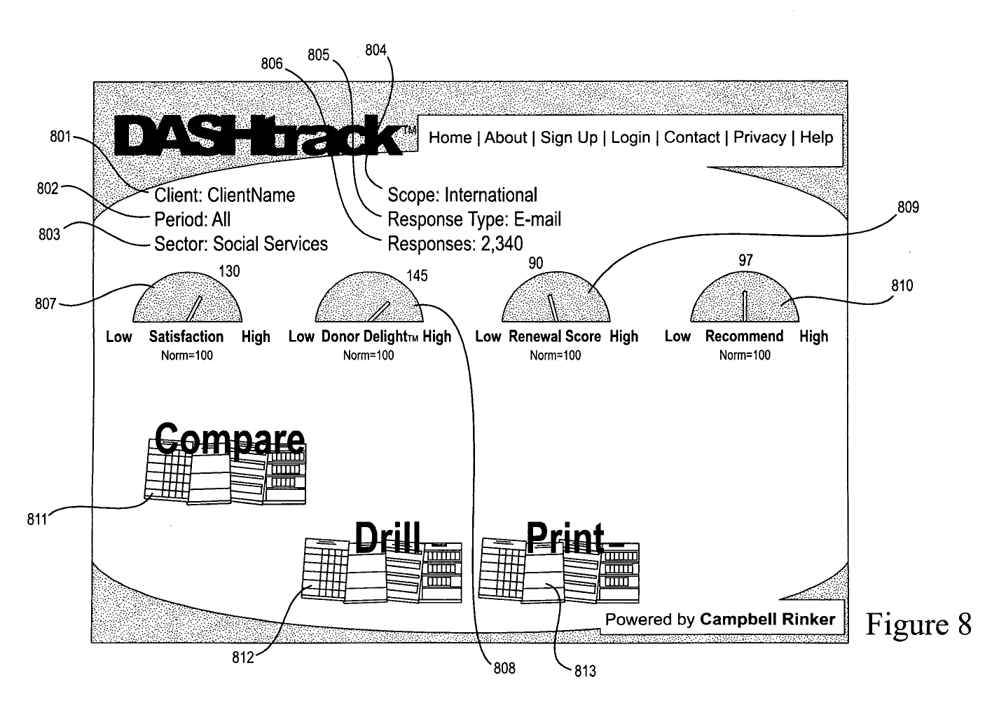

Referring to FIG. 8 an exemplary embodiment of a Results Dashboard on the Client Portal is shown with information fields 801 to 806 shown at the top. These information fields permit the client to specify the particular results they would like to display. The client information field 801 specifies the client name; the period field specifies the period for which the results are shown; the sector specifies the general type of charitable organization; the scope specifies the area for which the results are displayed; the response type specifies the method by which the donors responded; and the responses field indicates how many responses there were. Below the information fields are a series of results such as satisfaction score 807; donor delight score 808; renewal score 809; and recommend score 810. These results are displayed numerically and graphically like a speedometer. Below the results there are links to the comparison module 811, the drill-down module 812, and the print module 813. The comparison module 811 compares the results with a different set of results selected by the user. The drill-down module 812 provides more detailed data and the print module facilitates the printing of the displayed results and/or selected reports based on those results.

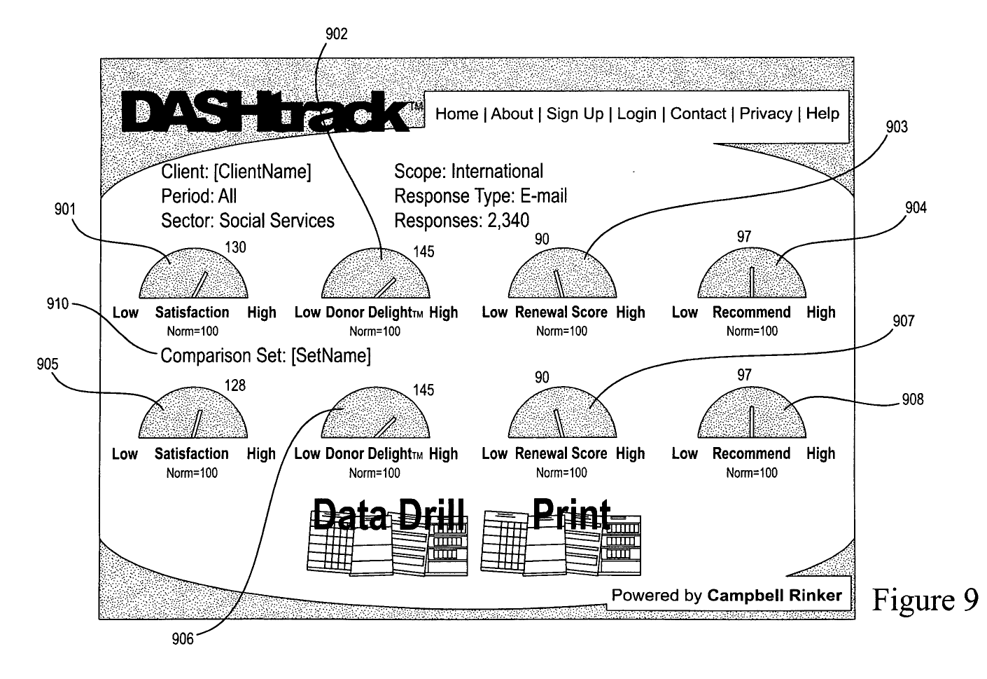

Referring to FIG. 9 an exemplary embodiment of a comparison module is shown with comparison set 910 below the base results. Satisfaction score 901 from the base results is shown directly above satisfaction score 905 from the comparison set 910; similarly donor delight score 902 from the initial results is shown directly above donor delight score 906 from the comparison set 910. Comparison Renewal Score 907 and Comparison Recommend Score 908 are similarly shown directly below base Renewal Score 903 and base Recommend Score 904 respectively.

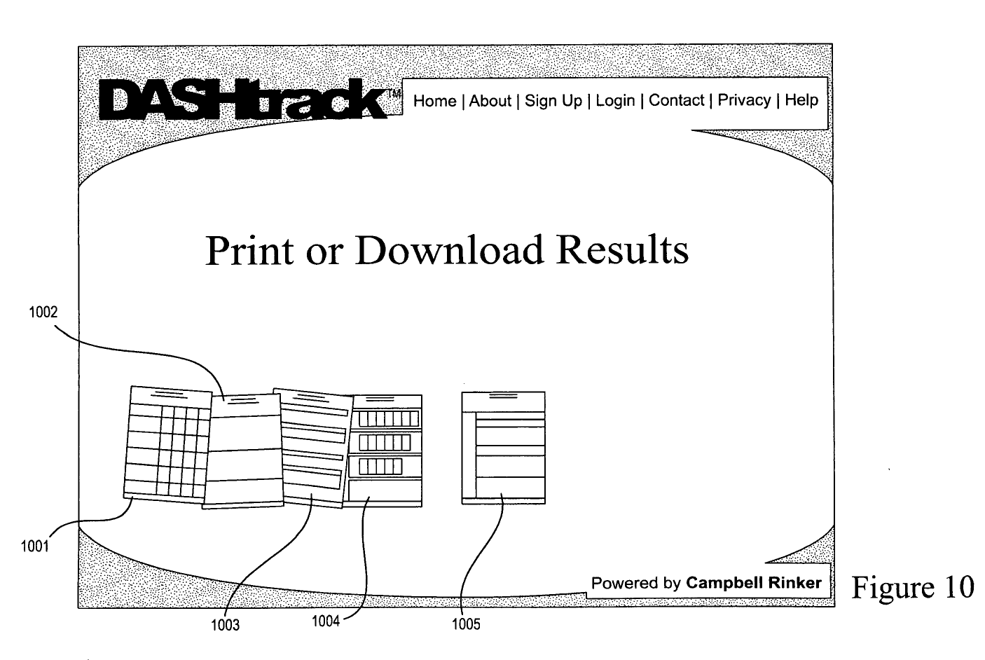

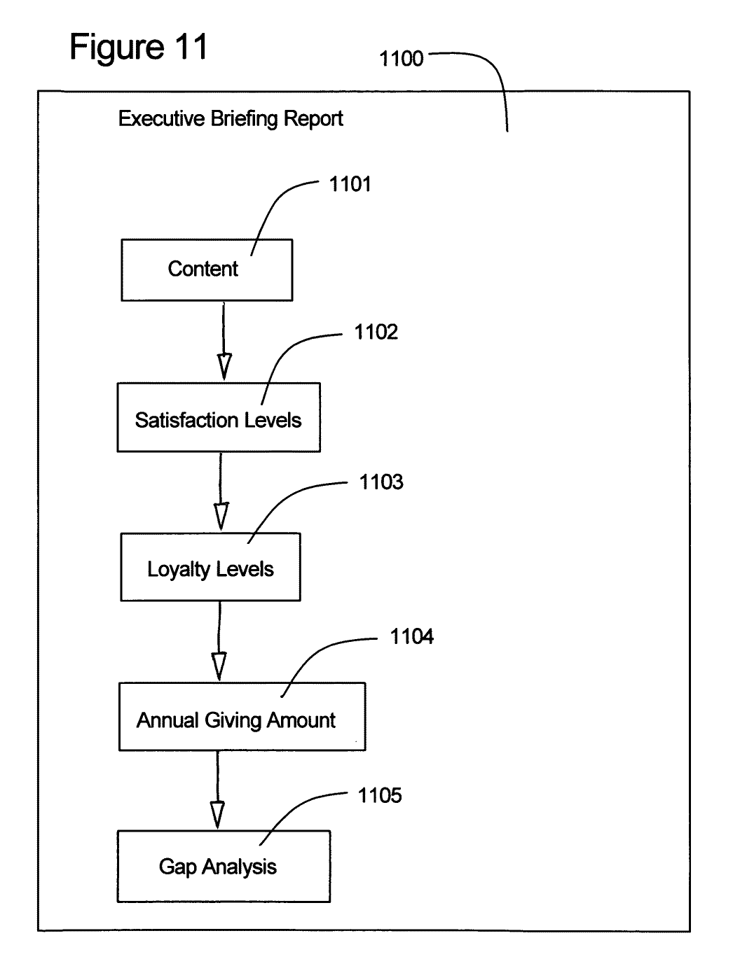

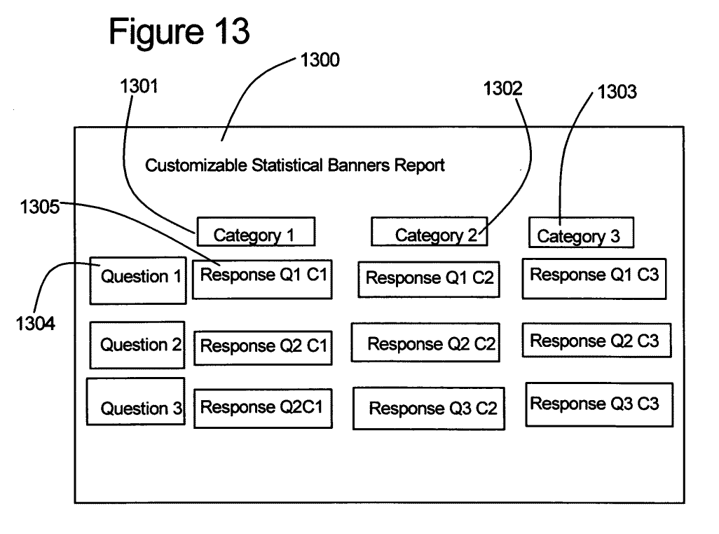

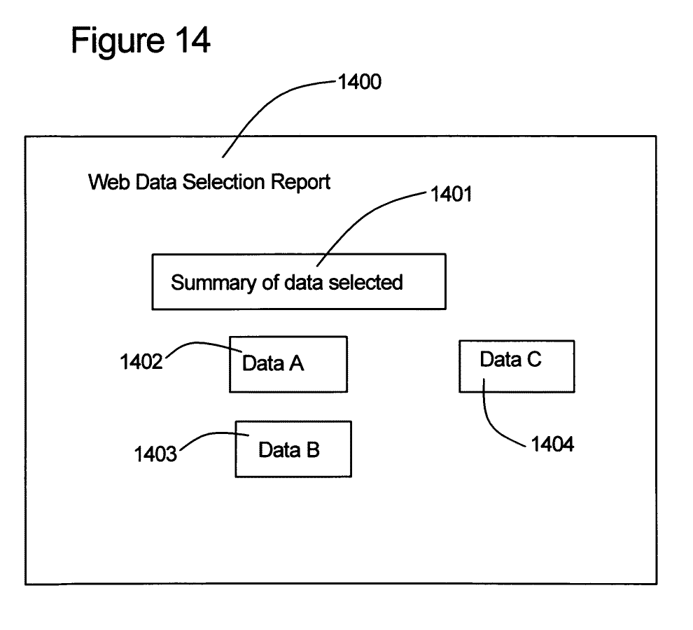

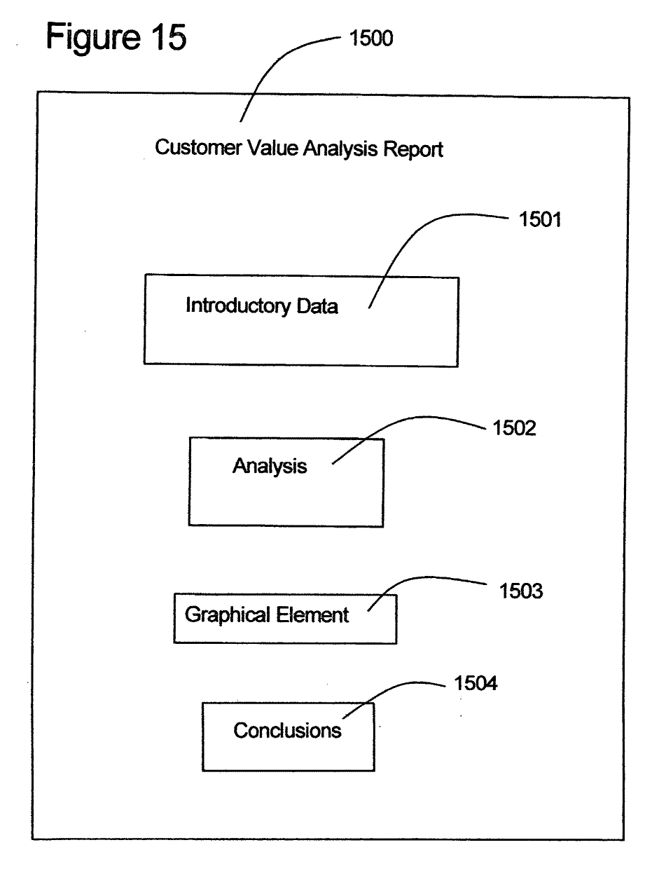

Referring to FIGS. 10 to 15, the print or download results module enables the user to select one of several reports from among five different report types. The user can select the executive briefing report icon 1001 to download or print the executive briefing report 1100 (which is shown on FIG. 11). Similarly the user can click the standard statistical banners report icon 1002 which enables the download or print of the standard statistical banners report 1200, or can select the customizable statistical banners report icon 1005 to view the customizable statistical banners report 1300 (shown in FIG. 13), or can select the web data selection report icon 1004 to select the web data selection report 1400 (shown in FIG. 14), or can select the customer value analysis report icon 1003 to view the customer value analysis report 1500 (shown in FIG. 15). These reports are individually illustrated and described as follows:

Referring to FIG. 11, the executive briefing report 1100 is illustrated in block diagram form. The purpose of this report is to provide information in aggregate for certain period determined by the client, arranged in a written report suitable for executive-level presentation, detailing survey response for each question in graphics and text and including data for comparable organizations where available. The first section entitled ‘content’ 1101 lists the contents of the report, the second section ‘satisfaction levels’ 1102 provides detailed information on satisfaction levels derived from the method of the present invention. Similarly detailed information is provided on loyalty levels 1103, annual giving amount 1104, and a standard GAP analysis 1105 offers an additional statistical perspective on the information.

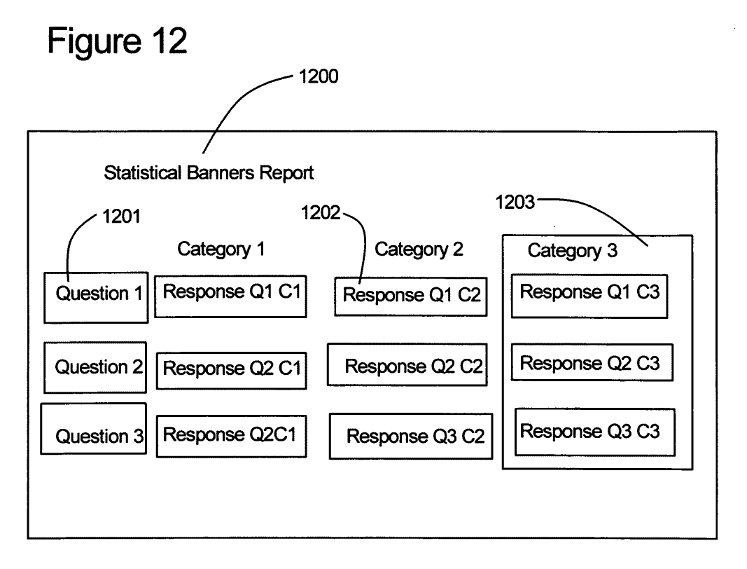

Referring to FIG. 12, a standard statistical banners report 1200 following the method of the present invention is illustrated in block diagram form. The purpose of this report is to allow the client to compare categories of donors between one another and identify any statistically significant differences between categories. The report facilitates the comparison of responses to different questions from different categories. For instance the section ‘Response Q1 C2’ 1202 provides information on responses from persons in Category 2 to ‘Question 1’ 1201. The categories are arranged in columns as for instance ‘Category 3’ 1203.

Referring to FIG. 13, a customizable statistical banners report 1300 following the method of the present invention is illustrated in block diagram form. Categories 1301, 1302 and 1303 are selectable by the user, that is, information from any category can be shown in any column of the report depending on user selections. For example if the user selects ‘Category 1’ for the column under that category heading 1301 and Question 1 for the row beside question heading 1304, then the customized response 1305, labeled ‘Response Q1 C1’ is displayed in the upper right hand cell of the table.

Referring to FIG. 14, a web data selection report 1400 is illustrated in summary form. The purpose of this report is to enable clients to select all of their data from the data-warehouse for transfer into a local storage system. The types of information provided by the report include all records, including recent donor-level data and aggregate date for a particular client. An embodiment of the report might involve three different data types donor data 1402, client data 1403 and aggregate data 1404, all selected by the client. A summary 1401 of three types of data is also provided with the report.

Referring to FIG. 15, a customer value analysis report 1500 is illustrated in summary form. This report provides all records in aggregate for a certain period of time determined by the client, in a manner that presents the correlation of various satisfaction indicators with the importance of those same indicators. This correlation allows donor relationship managers to identify the areas of communication and relationship which donors consider to be a priority and which the organization is perceived to either fulfill or not fulfill to their satisfaction. This report type is organized into introductory data 1501, analysis 1502, graphical element 1503 which displays the data in a visually comprehensive manner for clients, and conclusions 1504. By reading these reports clients have the tools they need to adjust donor messages and tactics in response to the data.

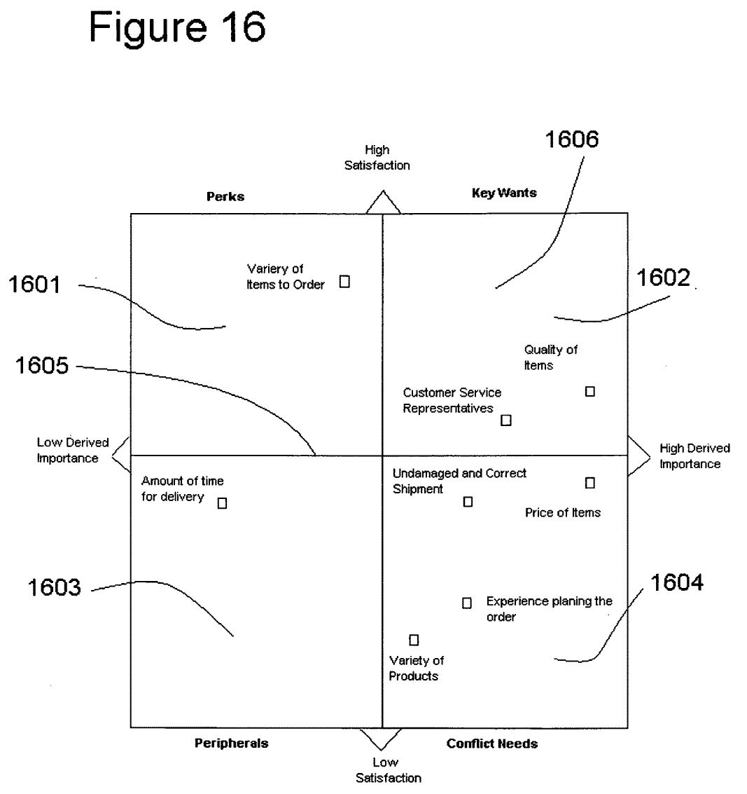

Referring to FIG. 16, an exemplary embodiment of the graphical element 1503 introduced in FIG. 15 is provided. The graphical element consists of two axes, a horizontal derived importance axis 1605 and a vertical satisfaction axis 1606. These axes define four quadrants: perks quadrant 1601 which has low importance/high satisfaction; key wants quadrant 1602 which has high satisfaction/high derived importance; peripherals quadrant 1603 which has low satisfaction/low importance; and critical needs quadrant 1604 which has low satisfaction/high derived importance. Any of the parameters or components of the survey data acquisition system can be placed within the framework of the axes 1605 and 1606 and displayed within a graphical element 1503.

This specification sets out working embodiments of the donor affinity tracking system but it is not exhaustive, other specific wording of the questions could be substituted and still fit within the scope of the invention, defined by the Claims based on this disclosure.

1. A donor affinity tracking system for non-profit enterprises and fundraising advisors, comprising:
a) a survey data acquisition questionnaire designed to measure a donor's satisfaction with the results of a donation plus the donor's affinity to a donee;
b) a client-donor database
c) a data-warehouse for questionnaire responses
in which information from the client-donor database is combined with survey data acquired from responses to the questionnaire and with information from the data-warehouse in data analysis that is useful in predicting of future donations from the donor to the donee, and in prioritizing fund-raising and donor affinity improvement efforts.

2. The donor affinity tracking system for non-profit enterprises and fundraising advisors system of claim 1, in which the questionnaire comprises:
a) a standardized set of questions designed to elicit satisfaction responses useful in measuring key components of a donor's satisfaction with the results of a donation;
b) a customized set of questions designed to elicit affinity responses useful in measuring key components of the donor's affinity for the donee;
c) using the affinity responses to identify which satisfaction components are most important to the donor, in order to weight the donor's satisfaction responses

3. The donor affinity tracking system for non-profit enterprises and fundraising advisors system of claim 1, in which a remotely accessible client portal is used to enable a client to directly customize reports.

4. The donor affinity tracking system for non-profit enterprises and fundraising advisors system of claim 1, in which the data analysis involves benchmarking, donor affinity metrics, and predictive metrics.

5. The donor affinity tracking system for non-profit enterprises and fundraising advisors system of claim 1, in which the results of the data analysis are used to generate customized reports for a client.

6. The donor affinity tracking system for non-profit enterprises and fundraising advisors system of claim 1, in which a first set of responses by a donor to a basic set of service affinity questions is followed with a second set of responses to an enhanced set of donor affinity questions, the second set of responses being then used to weight the responses from the first set responses and infer importance of affinity factors.

7. The donor affinity tracking system for non-profit enterprises and fundraising advisors system of claim 6, in which the first set of responses by a donor to the basic service affinity set of questions are combined with the second set of responses to the enhanced set of donor affinity questions, and fed to a response weighting algorithm which generates a future donation prediction score for the donor.

8. The donor affinity tracking system for non-profit enterprises and fundraising advisors system of claim 7, in which the basic service affinity set of questions comprises questions about:
a) Frequency and responsiveness of donee communications
b) Content of donee communications
c) Acknowledgement and/or reciprocation by the donee
d) Nature and approach of the solicitation

9. The donor affinity tracking system for non-profit enterprises and fundraising advisors system of claim 7, in which the enhanced set of donor affinity questions comprises question about:
a) Donor service quality expectations being met, unmet or exceeded
b) Whether the donor is likely to give again
c) Whether the donor is likely to discuss the donee
d) The priority the donor places on gifts to the donee.

10. The donor affinity tracking system for non-profit enterprises and fundraising advisors system of claim 2, in which:
a) a remotely accessible client portal is used to enable a client to directly customize reports;
b) the data analysis involves benchmarking, donor affinity metrics, and predictive metrics.:
c) a first set of responses by a donor to a basic set of service satisfaction questions is followed with a second set of responses to an enhanced set of donor affinity questions, the second set of responses being then used to weight the responses from the first set responses and infer importance of affinity factors;
d) the first set of responses by a donor to the basic service satisfaction set of questions are combined with the second set of responses to the enhanced set of donor affinity questions, and fed to a response weighting algorithm which generates a future donation prediction score for the donor.

11. The donor affinity tracking system for non-profit enterprises and fundraising advisors system of claim 10, in which the basic set of service satisfaction questions comprises questions about:
a) Frequency and responsiveness of donee communications
b) Content of donee communications
c) Acknowledgement and/or reciprocation by the donee
d) Nature and approach of the solicitation

12. The donor affinity tracking system for non-profit enterprises and fundraising advisors system of claim 10, in which the enhanced set of donor affinity questions comprises question about:
a) Donor service quality expectations being met, unmet or exceeded
b) Whether the donor is likely to give again
c) Whether the donor is likely to discuss the donee
d) The priority the donor places on gifts to the donee.
